(19) United States
(12) Patent Application Publication
(10) Pub. No.: US 2011/0155310 A1
(43) Pub. Date: Jun. 30, 2011

(54) BRAIDED HOSE ASSEMBLY AND METHOD OF MANUFACTURING SAME

(76) Inventor: Stephen B. Cipielewski, Wolverine Lake, MI (US)

(21) Appl. No.: 12/648,890

(22) Filed: Dec. 29, 2009

(51) Int. Cl. B29C 47/88; B29C 47/04

(52) U.S. Cl. 156/244.13

(57) ABSTRACT

A process for forming a hose assembly having an inner liner that is formed of a polymeric fluorocarbon material. The hose assembly includes a reinforcing layer and a resin that is at least partly formed of a fluorocarbon polymer.

### FIELD

The present disclosure relates to a hose assembly and a related method for forming a hose assembly.

### BACKGROUND

This section provides background information related to the present disclosure which is not necessarily prior art.

U.S. Pat. No. 5,124,878 describes a coated braided hose assembly in which an organic polymeric material consisting essentially of a fluorocarbon polymer is dispersed in a reinforcing layer and connects the reinforcing layer to an inner fluorocarbon polymeric liner. U.S. Pat. No. 5,192,476 describes a method for forming the coated braided hose assembly of the type that is described in U.S. Pat. No. 5,124,878.

I have noted that the while the method described in U.S. Pat. No. 5,192,476 provides generalized information pertaining to the formation of an organic polymeric coating on a braided layer, the methodology described therein does not produce consistent bonding of the braided layer to the inner liner over most or substantially all of the outer surface of the inner liner. Accordingly, there remains a need in the art for an improved hose assembly and a method for its manufacture.

### SUMMARY

This section provides a general summary of the disclosure, and is not a comprehensive disclosure of its full scope or all of its features.

In one form the present teachings provide a process for forming a hose assembly that includes: providing an intermediate hose assembly with a hose structure and a layer of reinforcing material that is disposed about the hose structure, the hose structure comprising an inner liner that is formed of a polymeric fluorocarbon material; delivering a resin between the layer of reinforcing material and an outer surface of the hose structure, the resin comprising a fluorocarbon polymer; coupling the intermediate hose assembly to a drive wheel; operating the drive wheel to propel the intermediate hose assembly through a first heater and to dispense the intermediate hose assembly from the drive wheel into a second heater; heating the intermediate hose assembly in the second heater such that the resin is capable of bonding the layer of reinforcing material to the outer surface of the hose structure; cooling the intermediate hose assembly to cause the resin to bond the layer of reinforcing material to the outer surface of the hose structure and form the hose assembly; and operating a take-up mechanism to take up the hose assembly. The take-up mechanism is operated to take-up the hose assembly without tensioning the inner liner beyond a predetermined threshold.

In another form, the present teachings provide a process for forming a hose assembly that includes: providing an intermediate hose assembly with a hose structure and a layer of reinforcing material that is disposed about the hose structure, the hose structure comprising a inner liner that is formed of a polymeric fluorocarbon material; delivering a resin between the layer of reinforcing material and an outer surface of the hose structure, the resin comprising a fluorocarbon polymer; coupling the intermediate hose assembly to a drive wheel; operating the drive wheel to propel the intermediate hose assembly through a first heater and to dispense the intermediate hose assembly from the drive wheel into a second heater; heating the intermediate hose assembly in the second heater such that the resin is capable of bonding the layer of reinforcing material to the outer surface of the hose structure; and cooling the intermediate hose assembly to cause the resin to bond the layer of reinforcing material to the outer surface of the hose structure and form the hose assembly. The hose structure consists essentially of the inner liner and wherein the hose assembly is constructed such that at least 90% of an interior cylindrical planar surface of the layer of reinforcing material is bonded to the inner liner.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary hose assembly constructed in accordance with the teachings of the present disclosure;

FIG. 2 is a cross-sectional view taken along the line 2-2 of FIG. 1;

FIG. 3 is a schematic view of an exemplary intermediate hose assembly that is employed in the manufacture of the hose assembly of FIG. 1 in accordance with the teachings of the present disclosure;

FIG. 4 is a schematic illustration of an exemplary system for manufacturing the hose assembly of FIG. 1 in accordance with the teachings of the present disclosure;

FIG. 5 is a perspective view of a portion of the system of FIG. 4, showing the driven wheel of the wheel house in greater detail; and

FIG. 6 is a chart that discloses various process parameters for several exemplary hose assemblies constructed in accordance with the teachings of the present disclosure.

Corresponding reference numerals indicate corresponding parts throughout the several views of the drawings.

### DETAILED DESCRIPTION

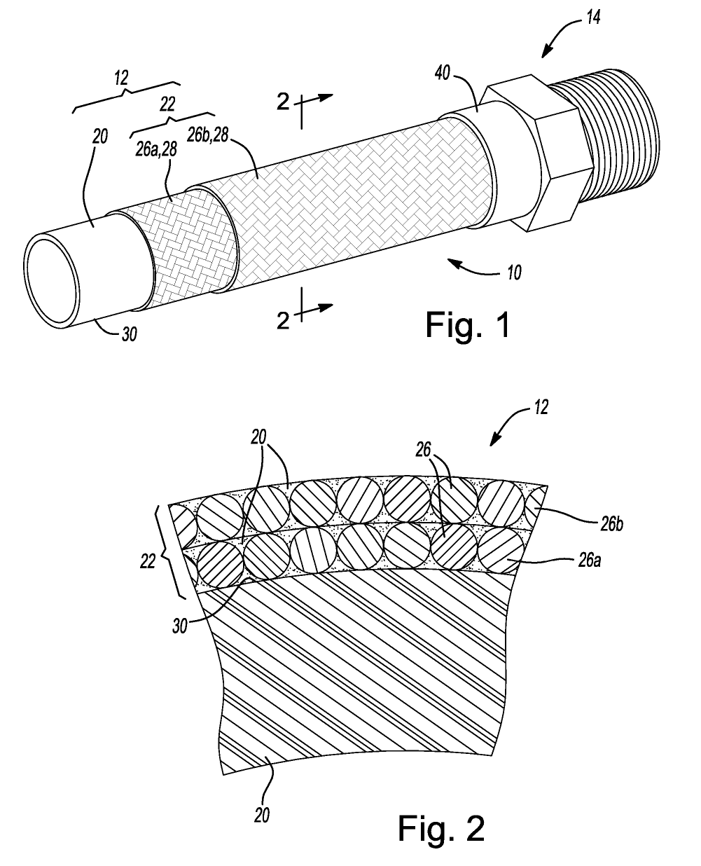

With reference to FIGS. 1 and 2, an exemplary braided hose assembly constructed in accordance with the teachings of the present disclosure is generally indicated by reference numeral 10. The braided hose assembly 10 can include a braided hose 12 and one or more fittings 14 that can be attached to one or both of the ends of the braided hose 12. The braided hose 12 can comprise an inner liner 20 and an outer reinforcement 22. The outer reinforcement 22 can be formed in one or more layers, with each layer comprising a reinforcing layer 26 and a coating material 28.

The inner liner 20 can be a tubular structure that can be formed of an extruded organic polymer, such as a fluorocarbon polymer. Exemplary fluorocarbon polymers include polytetrafluoroethylene (PTFE), fluorinated ethylene propylene (FEP), perfluoralkoxy (PFA), and ethylenetetrafluoroethylene (ETFE) and are available from various sources, including E.I. DuPont de Nemours and Company of Wilmington, Del.

Each reinforcing layer 26 can be formed of a material that is permeable to a solution that includes the coating material 28, as will be described in more detail, below. In one example, the reinforcing layer 26 can comprise a braided or woven layer that can be pre-assembled and installed over the inner liner 20 or could be formed over the inner liner 20 (e.g., woven onto the inner liner 20). In another example, the reinforcing layer 26 can comprise a perforated layer that can be pre-formed and installed over the inner liner 20. The reinforcing layer 26 can be formed of any desired reinforcing material, such as fiberglass, aramid and combinations thereof. In the particular example provided, the braided hose assembly 10 includes a first reinforcing layer 26a and a second reinforcing layer 26b and each of the first and second reinforcing layers 26a and 26b is formed entirely of aramid fibers that are commercially available from E.I. DuPont de Nemours and Company of Wilmington, Del. under the KEVLAR® trademark. Another suitable aramid is commercially available from Teijin Aramid of Amhem, The Netherlands under the TWARON® trademark.

The coating material 28 can comprise an organic polymeric material that can be distributed on and in each reinforcing layer 26. The coating material 28 can be distributed within the interstices or pores of each reinforcing layer 26 forming a single layer therewith such that each reinforcing layer 26 is disposed in an associated layer of the coating material 28. The coating material 28 can be disposed between the outer surface 30 of the inner liner 20 and an adjacent reinforcing layer 26 (i.e., the first reinforcing layer 26a in the example provided) and as such, it will be appreciated that the coating material 28 can bond the inner liner 20 to the reinforcing layer that is adjacent to the inner liner 20 (i.e., the first reinforcing layer 26a in the example provided). It will also be appreciated that where the outer reinforcement 22 employs multiple reinforcing layers 26 (as in the present example), the coating material 28 can be formed in discrete steps or increments as will be described in more detail below.

The coating material 28 can comprise a suitable fluorocarbon polymer, such as polytetrafluoroethylene (PTFE), fluorinated ethylene propylene (FEP), perfluoralkoxy (PFA), and ethylenetetrafluoroethylene (ETFE) and are available from various sources, including E.I. DuPont de Nemours and Company of Wilmington, Del.

The coating material 28 can be applied to the reinforcing layer 26 (either to individual layers or to several layers) prior to the assembly of the reinforcing layer(s) 26 to the inner liner 20. Where the reinforcing layer 26 comprises a woven or braided construction, the coating material 28 can be applied to or incorporated into the fibers that are employed to form the weave or braid.

Alternatively, the coating material 28 may be mixed in a solution with an appropriate carrier, such as water, and dispensed on and in some instances, through the reinforcing layer(s) 26 (either individually or to several layers simultaneously) either before or after the reinforcing layer(s) 26 have been installed to the inner liner 20. As used herein when describing the application of the solution to the reinforcing layer(s) 26, the term “dispensing” will be understood as comprising any activity that results in the wetting of the reinforcing layer(s) 26 with the solution, including spraying or pouring the solution onto the reinforcing layer(s) 26, as well as submerging the reinforcing layer(s) 26 in the solution. It will be appreciated that the carrier can distribute the coating material 28 throughout the pores or interstices and that the reinforcing layer(s) 26 can be dried thereafter and heated to sinter the coating material 28, which fuses the coating material 28.

The fittings 14 can be conventional in their construction and need not be described in significant detail herein. Briefly, each fitting 14 can include an insert portion (not specifically shown), which can be inserted into and engage the inside surface of the inner liner 20, and a coupling portion 40 that can be fitted over the outer reinforcement 22 and engaged to the outer reinforcement 22 so as to generate a clamping force that clamps the braided hose 12 to the insert portion (to thereby form a seal of a desired strength between the inner liner 20 and the insert portion as well as to axially fix the braided hose 12 to the fitting 14). As is known, the insert portion can include hose barbs (not specifically shown) or the like for engaging the inner liner 20 and the coupling portion 40 can be swaged or crimped to generate the clamping force.

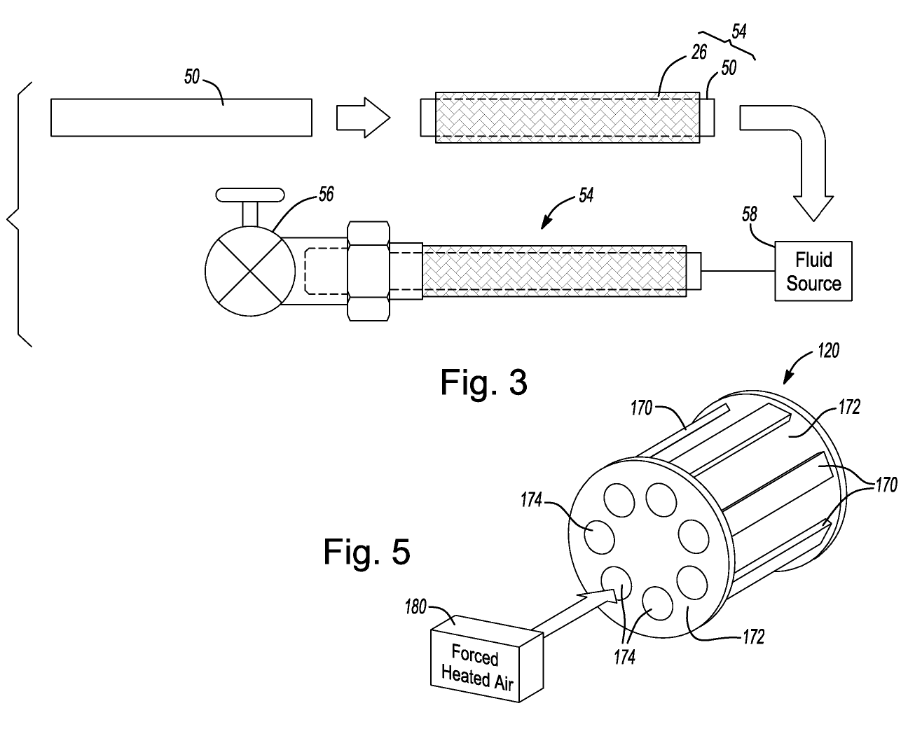

With reference to FIGS. 2 and 3, an exemplary process for forming the braided hose 12 includes the assembly or installation of a reinforcing layer 26 to a hose structure 50 to form an intermediate hose assembly 54. The hose structure 50 includes the inner liner 20 and may include one or more previously installed or assembled reinforcing layers 26. For purposes of this discussion, however, the hose structure 50 does not include any previously installed or assembled reinforcing layer 26 and the reinforcing layer 26 (i.e., the first reinforcing layer 26a) is assembled/installed to the inner liner 20 via a weaving or braiding process that is well known in the art.

The inner liner 20 can be a continuous length of tubing, or could be formed from several discrete lengths of tubing in which some form of coupler (not specifically shown) is disposed between adjacent lengths of the tubing. Similarly, the reinforcing layer 26 can be formed as a single, continuous length over the inner liner 20 (regardless of whether or not the inner liner 20 is formed by one or more lengths of tubing), or could be formed in several discrete sections, with each section being associated with a discrete length of tubing as in the embodiment that is illustrated. Where a coupler is employed, the coupler can include a conventional and commercially available barbed union hose coupler and a pair of conventional and commercially available hose clamps that are employed to sealingly couple the ends of associated lengths of tubing to an associated end of the barbed union hose coupler. A flow valve 56 can be installed to a first end of the inner liner 20, while an opposite, second end of the inner liner 20 can be coupled to a source of fluid pressure 58. In the particular example provided, the source of fluid pressure comprises a tank having pressurized nitrogen therein. It will be appreciated that other types of fluid may be employed, including other inert gases, non-inert gases (e.g., air), or water, for example. The temperature of the fluid that enters the inner liner 20 at the second end can be greater than or equal to 0° F. and less than or equal to 200° F. and that the pressure of the fluid that enters the inner liner 20 at the second end can be greater than or equal to 5 p.s.i.g. and less than or equal to 100 p.s.i.g., and more preferably greater than or equal to 20 p.s.i.g. and less than or equal to 60 p.s.i.g. The flow valve 56 can be configured to discharge the fluid from the inner liner 20 at a predetermined rate, such as a rate that is greater than or equal to 2 cc per minute and preferably greater than or equal to 5 cc per minute. It will be appreciated that various factors, including the inside diameter of the inner liner 20, the wall thickness of the inner liner 20, the number of reinforcing layers 26, and the amount of heat that is transmitted to the inner liner 20 during subsequent processing of the intermediate hose assembly 54 can factor into the rate that is selected.

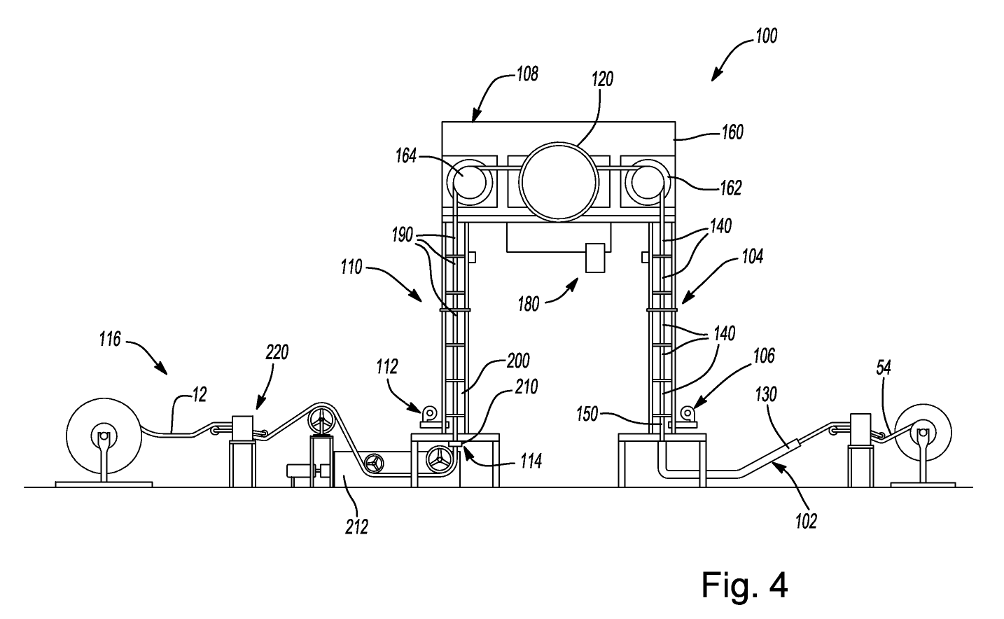

With reference to FIGS. 2 and 4, the intermediate hose assembly 54 can be processed through a coating application and sintering system 100 that can include a dispersion tank 102, a first heater 104, a first air column heater 106, a wheel house 108, a second heater 110, a second air column heater 112, a quencher 114 and a take-up mechanism 116. The wheel house 108 can include a drive wheel 120 that can be employed to provide propulsive power to draw the intermediate hose assembly 54 through the dispersion tank 102 and the first heater 104 and dispense the intermediate hose assembly 54 into the second heater 110 as will be explained in more detail below.

The dispersion tank 102 can include a tank structure 130 (e.g., a tube, a tank, a vessel or a trough) and can be filled with the solution that includes the carrier and the coating material 28. The solution can comprise between about 20% to about 60% (by weight) of the carrier, about 30% to about 65% (by weight) of the coating material 28, and about 0% to about 30% (by weight) of additives, including surfactants and ultraviolet light inhibitors. In the particular example provided, the carrier is water, the coating material 28 is a TEFLON® PTFE TE-3859 aqueous fluoropolymer dispersion marketed by E.I. DuPont de Nemours and Company of Wilmington, Del. (the TEFLON® PTFE TE-3859 includes a surfactant), and the additives include a W-7014 AURASPERSE® II carbon black additive manufactured by Engelhard Corporation of Iselin, N.J. I have found that the TE-3859 dispersion and an additional amount of surfactant can be mixed in the ratio of 0.97 lb. TE-3859:0.03 lb. additional surfactant to form a satisfactory solution where the additives do not include carbon black, and that where the additives include carbon black, the ratio of TE-3859, additional surfactant, carbon black and additional water can be 0.768 lb. TE-3859:0.012 lb. additional surfactant: 0.037 lb. carbon black: 0.183 lb. additional water. It will be appreciated that the amount of water in these two solutions may be varied as necessary and that the viscosity of the solution may be employed as a gauge to determine whether additional water is necessary. I have found that as aramid fibers such as KEVLAR® fibers, absorb water, the use of an aqueous coating material 28 (i.e., fluoropolymer in the example provided) such that the coating material 28 can be distributed throughout the aramid fiber.

The intermediate hose assembly 54 can be submerged in the solution in the tank structure 130 to apply the dispersion (i.e., the coating material 28) on and in the pores or interstices of the reinforcing layer 26. When the hose structure 50 consists essentially of the inner liner 20 and does not include a previously installed/assembled reinforcing layer, I have found that the outer surface 30 of the inner liner 20 is sufficiently coated with the coating material 28 and that it is unnecessary to repetitively flex hose structure 50 to “open” the fibers of a braided or woven reinforcing layer.

The intermediate hose assembly 54 exits the dispersion tank 102 and is drawn through the first heater 104 to remove the carrier from the intermediate hose assembly 54. In the particular example provided, the first heater 104 is a vertically oriented heater and comprises a plurality of infra-red heaters 140 that are arranged in five (5) discrete zones. The infra-red heaters 140 can be operated to heat the intermediate hose assembly 54 to a desired temperature. It will be appreciated that the manufacturer of the coating material 28 may provide various recommendations concerning one or more of the temperatures for drying or sintering the coating material 28 (the manufacturer of the particular coating material in the example disclosed herein suggests that the desired temperature is about 250° F.). The temperature of each infra-red heater 140 may be set based on several criteria, including (without limitation): the lineal speed at which the intermediate hose assembly is drawn through the first heater 104, the diametrical size of the intermediate hose assembly 54, and the quantity of reinforcing layers 26 in the intermediate hose assembly 54. in Each of the infra-red heaters 140 can be set to a temperature (i.e., an output temperature) of between 250° F. and 600° F. but in the particular example provided, each of the infra-red heaters 140 is set to a temperature of between 300° F. and 350° F.

The first air column heater 106 can be employed to generate a flow of heated air that can be directed through the air column 150 surrounding the intermediate hose assembly 54 as it travels through the first heater 104. The first air column heater 106 can output heated air at a temperature of between 150° F. and 350° F., and more preferably between 200° F. and 250° F., to aid in the removal of the carrier from the intermediate hose assembly 54. Alternatively, a flow of ambient temperature air could be directed through the air column 150, but variation in the humidity and temperature of the unheated air may cause an undesired level of variation in the drying of the intermediate hose assembly 54. As another alternative, the first air column heater 106 may be omitted altogether.

In situations where a source of heated flowing air is provided to the air column 150 adjacent to the intermediate hose assembly 54, it is possible to reliably dry or substantially dry the intermediate hose assembly 54 such that the temperature of the inner liner 20/the intermediate hose assembly 54 is less than 250° (i.e., the recommended temperature driving off the carrier to thereby dry the intermediate hose assembly 54), which may be beneficial in some situations where it is undesirable to maintain the inner liner 20 at elevated temperatures for an extended period of time.

In addition to the drive wheel 120, the wheel house 108 can include an enclosure 160, a first idler wheel 162 and a second idler wheel 164. The enclosure 160 can house the drive wheel 120 and the first and second idler wheels 162 and 164 and can include an inlet, which can be aligned to an output side of the first heater 104 to receive the intermediate hose assembly 54 therefrom, and an outlet that can be aligned to an input side of the second heater 110 to permit the intermediate hose assembly 54 to be discharged from the wheel house 108 to the second heater 110. The first idler wheel 162 can be configured to receive the intermediate hose assembly 54 as it enters the wheel house 108 from the first heater 104. The drive wheel 120 may be coupled to a conventional source of rotary power (e.g., via pulleys and a belt; via sprockets and a chain; or via direct drive with an output shaft of a motor). The source of rotary power may be configured to operate the first driven wheel at a single and continuous speed, or may be configured to operate the first driven wheel at a speed that may be selected by the operator of the coating application and sintering system 100. With additional reference to FIG. 5, the drive wheel 120 can comprise a drum-like structure having a plurality of bars 170 that disposed between a pair of plates 172 to form a generally open wheel structure. The intermediate hose assembly 54 can be wrapped about the outer circumference of the drive wheel 120 one or more times to cause the intermediate hose assembly 54 to grippingly engage the drive wheel 120 so that rotation of the drive wheel 120 will cause movement of the intermediate hose assembly 54 through the first heater 104. An auxiliary fan or air heater 180 can be coupled in fluid communication with the interior of the drive wheel 120 to discharge a flow of (heated) air between the bars 170 in the drive wheel 120 and against the intermediate hose assembly 54 that is wrapped on the drive wheel 120. In the example provided, a plurality of holes 174 are formed through one of the plates 172, and air exiting the auxiliary heater 180 can pass through the holes 174 as the drive wheel 120 rotates. The flow of air passing through the drive wheel 120 can be employed to ensure that the carrier is fully removed from the intermediate hose assembly 54 and/or to pre-heat the intermediate hose assembly 54 prior to its introduction into the second heater 110. In the particular example provided, the auxiliary air heater 180 is configured to output a flow of air having a temperature of between 400° F. and 475° F. Preferably, the top of the second idler wheel 164 is spaced apart from the quencher 114 by a distance that does not permit the weight of the intermediate hose assembly 54 suspended therebetween to stretch or elongate the inner liner 20 by an amount that exceeds a predetermined threshold. In the particular example provided, the top of the second idler wheel 164 is spaced apart from the quencher 114 by a distance that is less than about 15 feet. The second idler wheel 164 can be configured to receive the intermediate hose assembly 54 as it is discharged from the drive wheel 120 and to discharge the intermediate hose assembly 54 into the second heater 110.

It will be appreciated that in the particular example provided, the characterization of the first and second idler wheels 162 and 164 as being “idler” wheels does not necessarily mean that the first idler wheel 162 and/or the second idler wheel 164 is/are not driven wheels, but rather that these wheels are not employed as the main means for moving the intermediate hose assembly 54 upwardly through the first heater 104. In the particular example provided, both of the first and second idler wheels 162 and 164 are rotated under a source of rotary power to reduce or eliminate the dragging of the intermediate hose assembly 54 against the surfaces of the first and second idler wheels 162 and 164.

The intermediate hose assembly 54 exits the wheel house 108 and is lowered or dispensed into the second heater 110 to remove various solution additives (e.g., the surfactant) from the intermediate hose assembly 54, as well as to sinter the coating material 28. In the particular example provided, the second heater 110 is vertically oriented and comprises a plurality of infra-red heaters 190 that are arranged in five (5) discrete zones. The infra-red heaters 190 can be operated to heat the intermediate hose assembly 54 to one or more desired temperatures and at one or more desired rates. The temperature of each infra-red heater 190 may be set based on several criteria, including (without limitation): the lineal speed at which the intermediate hose assembly is drawn through the first heater 104, the diametrical size of the intermediate hose assembly 54, and the quantity of reinforcing layers 26 in the intermediate hose assembly 54. In the particular example provided, each of the infra-red heaters 190 is set to a temperature (i.e., an output temperature) of between 720° F. and 795° F. In the particular example provided, the coating material 28 must reach a temperature of approximately 639° F. to melt.

The second air column heater 112 can be employed to generate a flow of heated air that can be directed through the air column 200 surrounding the intermediate hose assembly 54 as it travels through the second heater 110. The second air column heater 112 can output heated air at a temperature of between 300° F. and 350° F. to aid in the removal of the solution additives from the intermediate hose assembly 54 as well as to improve the rate at which heat is transferred to the coating material 28. Alternatively, the second air column heater 112 may be omitted altogether.

When a source of heated flowing air is provided to the air column 200 adjacent to the intermediate hose assembly 54, it is possible to reliably heat the coating material 28 more rapidly (as compared with situations where heated flowing air is not employed). As a result of conduction, heat employed to sinter the coating material 28 will ultimately migrate into the inner liner 20. In situations where it is undesirable to maintain the inner liner 20 at elevated temperatures for an extended period of time, it is beneficial to sinter the coating material 28 in a more rapid fashion to thereby reduce the amount of heat that is transmitted into the inner liner 20. It will be appreciated that the fluid (e.g., nitrogen in the example provided) that flows through the inner liner 20 will aid in removing heat from the inner liner 20.

The quencher 114, which is conventional in its construction and operation, may be positioned adjacent to the exit of the second heater 110 and employed to quench or cool the intermediate hose assembly 54 such that the coating material 28 solidifies in a single and uniform layer. It will be appreciated that the hose assembly 12 is formed once the coating material 28 has solidified. In the particular example provided, the quencher 114 includes a quench ring 210 and a quench tank 212. The quench ring 210 can be received about the intermediate hose assembly 54 as it exits the second heater 110 and can direct a cooling fluid onto the intermediate hose assembly 54. In the particular example provided, the cooling fluid is water, but it will be appreciated that other fluids, including air, can be employed in the alternative. The intermediate hose assembly 54 that exits the quench ring 210 can be received into the quench tank 212, which can hold a cooling fluid, such as water, that can be employed to further cool the coating material 28. It will be appreciated that various heat exchangers and pumps may be employed to maintain a temperature of the cooling fluid in the quench tank 212 and/or exiting the quench ring 210 at a desired temperature.

The take-up mechanism 116, which may also be conventional in its construction, is configured to take-up the braided hose 12 as it is discharged from the quencher 114. In this regard, the take-up mechanism 116 includes a pay-out drive 220 that is operated so as not to tension a predetermined length of any portion of the intermediate hose assembly 54 (particularly the inner liner 20) that is located between the pay-out drive 220 and the drive wheel 120 beyond a predetermined threshold. The predetermined threshold can be associated with an elongation of a predetermined length of the inner liner 20 when the predetermined length of the intermediate hose assembly 54 is passing through the second heater 110. The predetermined length can be 12 inches, for example, and the elongation is less than or equal to 0.5% (i.e., 0.06 inch elongation per 12 inches of the intermediate hose assembly 54). Preferably the elongation is less than or equal to 0.25% (i.e., 0.03 inch elongation per 12 inches of the intermediate hose assembly 54) and more preferably the elongation is less than or equal to 0.125% (i.e., 0.015 inch elongation per 12 inches of the intermediate hose assembly 54).

In situations where multiple reinforcing layers 26 are desired, the above process may be repeated as desired to sequentially add reinforcing layers 26 that are encased in the sintered coating material 28.

I have found that after sintering of the coating material 28 and quenching, at least 90% of the exterior surface area of the inner liner 20 is bonded by the sintered coating material 28 to reinforcing layer 26 that is adjacent to the inner liner 20 (i.e., the reinforcing layer 26a in the example provided).

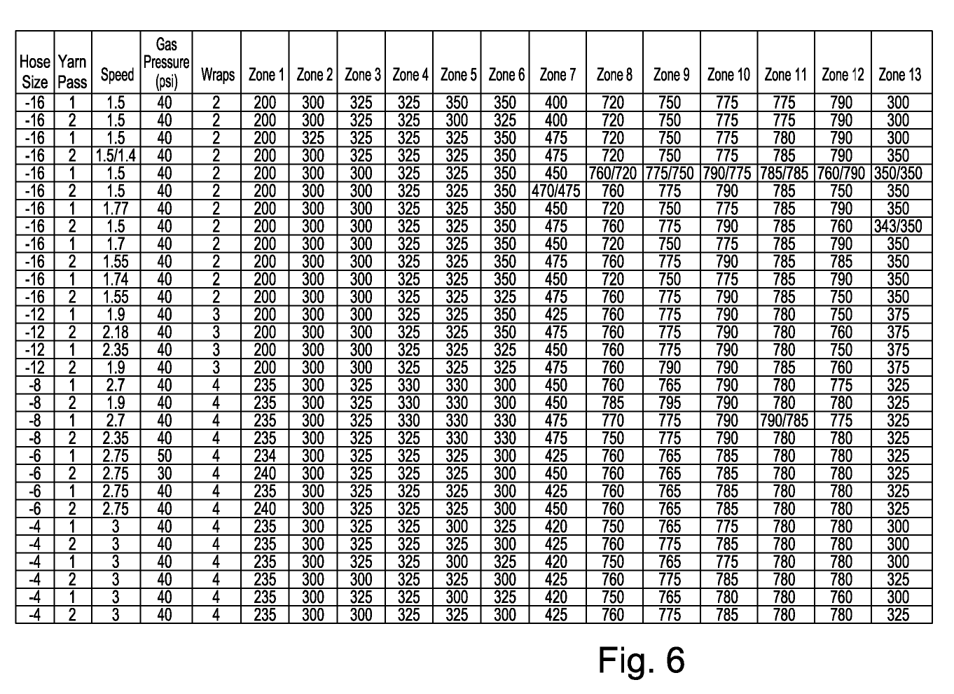

Several examples are provided in the table of FIG. 6. In these examples, the inner liner 20, the reinforcing layer(s) 26, the solution and the coating material 28 are as described above. In the column labeled “Hose Size”, a −4 hose has a nominal inside diameter/outside diameter (ID/OD) of 0.216 inch/0.448 inch; a −6 hose has a nominal ID/OD of 0.300 inch/0.594 inch; a −8 hose has a nominal ID/OD of 0.401 inch/0.735 inch; a −12 hose has a nominal ID/OD of 0.645 inch/1.034 inch; and a −16 hose has a nominal ID/OD of 0.876 inch/1.237 inch. The column labeled “Speed” is the lineal speed of the intermediate hose assembly 54 in feet per minute as it passes through the first heater 104. The column labeled “Gas Pressure” is the pressure of the fluid that is introduced to the inner liner 20. The column labeled “Wraps” is the number of times the intermediate hose assembly 54 is wrapped about the exterior of the drive wheel 120. The column labeled “Zone 1” is the output temperature (in degrees Fahrenheit) of the first air column heater 106. The columns labeled “Zone 2” through “Zone 6” are the output temperatures (in degrees Fahrenheit) for each of the five infra-red heaters 140 in the first heater 104. The column labeled “Zone 7” is the output temperature (in degrees Fahrenheit) of the auxiliary heater 180. The columns labeled “Zone 8” through “Zone 12” are the output temperatures (in degrees Fahrenheit) for each of the five infra-red heaters 190 in the second heater 110. The column labeled “Zone 13” is the output temperature (in degrees Fahrenheit) of the second air column heater 112.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A process for forming a hose assembly comprising:
providing an intermediate hose assembly with a hose structure and a layer of reinforcing material that is disposed about the hose structure, the hose structure comprising an inner liner that is formed of a polymeric fluorocarbon material;
delivering a resin between the layer of reinforcing material and an outer surface of the hose structure, the resin comprising a fluorocarbon polymer;
coupling the intermediate hose assembly to a drive wheel;
operating the drive wheel to propel the intermediate hose assembly through a first heater and to dispense the intermediate hose assembly from the drive wheel into a second heater;
heating the intermediate hose assembly in the second heater such that the resin is capable of bonding the layer of reinforcing material to the outer surface of the hose structure;
cooling the intermediate hose assembly to cause the resin to bond the layer of reinforcing material to the outer surface of the hose structure and form the hose assembly; and
operating a take-up mechanism to take up the hose assembly;
wherein the take-up mechanism is operated to take-up the hose assembly without tensioning the inner liner beyond a predetermined threshold.

2. The method of claim 1, wherein the predetermined threshold is associated with an elongation of a predetermined length of the inner liner when the predetermined length of the intermediate hose assembly is passing through the second heater.

3. The method of claim 2, wherein the predetermined length is 12 inches and wherein the elongation is less than or equal to 0.5%.

4. The method of claim 3, wherein the elongation is less than or equal to 0.25%.

5. The method of claim 4, wherein the elongation is less than or equal to 0.125%.

6. The method of claim 1, further comprising dispensing a fluid into the inner liner before the intermediate hose assembly is introduced to the second heater, the fluid having a temperature that is greater than or equal to 0° F. and less than or equal to 200° F. when the fluid is introduced to the inner liner.

7. The method of claim 6, wherein a pressure of the fluid that is dispensed into the inner liner is greater than or equal to 5 p.s.i.g. and less than or equal to 100 p.s.i.g.

8. The method of claim 7, wherein the pressure of the fluid that is dispensed into the inner liner is greater than or equal to 20 p.s.i.g. and less than or equal to 60 p.s.i.g.

9. The method of claim 1, further comprising flowing a fluid through the inner liner when the intermediate hose assembly is disposed in the second heater.

10. The method of claim 1, wherein the first heater comprises one or more infrared heaters and wherein the method further comprises flowing heated air through an air column in the first heater.

11. The method of claim 10, wherein a temperature of the heated air exits an air heater at a temperature that is greater than or equal to 200° F.

12. The method of claim 1, wherein the hose structure consists essentially of the Inner liner and wherein the hose assembly is constructed such that at least 90% of an interior cylindrical planar surface of the layer of reinforcing material is bonded to the inner liner.

13. The method of claim 1, wherein the first heater comprises an infra-red heater that is set at a temperature that is greater than or equal to 300° F.

14. The method of claim 13, wherein the temperature is greater than or equal to 325°.

15. The method of claim 1, wherein the solution includes a carrier and wherein at least 90% of the carrier is removed from the intermediate hose assembly prior to entry of the intermediate hose assembly into the second heater.

16. The method of claim 1, wherein the second heater comprises one or more infra-red heaters and wherein the method further comprises flowing heated air through an air column in the second heater.

17. The method of claim 15, wherein a temperature of the heated air exits an air heater at a temperature that is greater than or equal to 290° F.

18. The method of claim 1, wherein the first heater is vertically oriented.

19. The method of claim 1, wherein the second heater is vertically oriented.

20. A process for forming a hose assembly comprising:
providing an intermediate hose assembly with a hose structure and a layer of reinforcing material that is disposed about the hose structure, the hose structure comprising a inner liner that is formed of a polymeric fluorocarbon material;
delivering a resin between the layer of reinforcing material and an outer surface of the hose structure, the resin comprising a fluorocarbon polymer;
coupling the intermediate hose assembly to a drive wheel;
operating the drive wheel to propel the intermediate hose assembly through a first heater and to dispense the intermediate hose assembly from the drive wheel into a second heater;
heating the intermediate hose assembly in the second heater such that the resin is capable of bonding the layer of reinforcing material to the outer surface of the hose structure; and
cooling the intermediate hose assembly to cause the resin to bond the layer of reinforcing material to the outer surface of the hose structure and form the hose assembly;
wherein the hose structure consists essentially of the inner liner and wherein the hose assembly is constructed such that at least 90% of an interior cylindrical planar surface of the layer of reinforcing material is bonded to the inner liner.
